(19) United States
(12) Patent Application Publication
(10) Pub. No.: US 2025/0029216 A1
(43) Pub. Date: Jan. 23, 2025

(54) METHOD, APPARATUS, ELECTRONIC DEVICES, AND STORAGE MEDIUM OF IMAGE PROCESSING

(71) Applicant: Beijing Zitiao Network Technology Co., Ltd., Beijing (CN)

(72) Inventor: Dikai Fan, Beijing (CN)

(21) Appl. No.: 18/778,570

(22) Filed: Jul. 19, 2024

(30) Foreign Application Priority Data
Jul. 19, 2023 (CN) 202310889513.1

(51) Int. Cl. G06T 5/70; G06T 7/50; G06T 7/70; G06T 15/04

(52) U.S. Cl. CPC G06T 5/70; G06T 7/50; G06T 7/70; G06T 15/04

(57) ABSTRACT

A method, an apparatus, an electronic device, and storage medium of image processing are provided. A pose of a virtual object associated with a target object is determined based on a pose of the target object in a real scene; a virtual image corresponding to the virtual object is generated based on the pose of the virtual object; a first target image is obtained based on the virtual image and a real scene image corresponding to the real scene; and a second target image is obtained by performing smoothing on the first target image. Thus, a virtual object can be added to a target object in a real-scene image, and the image distortion and image noise due to the addition can be reduced.

### CROSS REFERENCE

This application claims priority to Chinese Patent Application No. 202310889513.1, filed with the Chinese Patent Office on Jul. 19, 2023 and entitled “METHOD, APPARATUS, ELECTRONIC DEVICES, AND STORAGE MEDIUM OF IMAGE PROCESSING”, which is incorporated herein by reference in its entirety.

### FIELD

The present disclosure relates to the field of computer technologies, specifically to a method, an apparatus, an electronic device, and a storage medium of image processing.

### BACKGROUND

Virtual reality technology can present interactive virtual reality spaces to users, and its See-Through function can display real-time images of the real environment, enabling users to perceive the surrounding real environment and to interact with the external world. The implementation methods of see-through mainly include Optical See-Through (OST) and Video See-Through (VST). The former relies on a semi transparent optical synthesizer to present images of the real environment to users, while the latter captures real-time images of the real environment through a camera and presents the images on a display. Video See-Through allows complete occlusion between virtual objects and real objects. However, due to the limited processing capabilities of virtual reality devices, the see-through function they provide generally cannot accurately reconstruct the three-dimensional geometric information of the real environment, leading to difficulty in accurately adding virtual objects on its basis.

### SUMMARY

This summary section is provided to briefly introduce the ideas, which will be described in detail in the description section that follows. This summary section is not intended to identify the key or necessary features of the technical solution requiring protection, nor is it intended to limit the scope of the technical solution requiring protection.

In a first aspect, according to one or more embodiments disclosed herein, there is provided a method of image processing, comprising:
determining a pose of a virtual object associated with a target object based on a pose of the target object in a real scene;
generating a virtual image corresponding to the virtual object based on the pose of the virtual object;
obtaining a first target image based on the virtual image and a real scene image corresponding to the real scene; and
performing smoothing on the first target image to obtain a second target image.

In a second aspect, according to one or more embodiments disclosed herein, there is provided an apparatus of image processing, comprising:
a pose determining unit configured to determine a pose of a virtual object associated with a target object based on a pose of the target object in a real scene;
a first image processing unit configured to generate a virtual image corresponding to the virtual object based on the pose of the virtual object;
a second image processing unit configured to obtain a first target image based on the virtual image and a real scene image corresponding to the real scene; and
a third image processing unit configured to perform smoothing on the first target image to obtain a second target image.

In a third aspect, according to one or more embodiments disclosed herein, there is provided an electronic device, comprising: at least one memory and at least one processor. The memory is configured to store program codes, and the processor is configured to call the program codes stored in the memory to cause the electronic device to execute the methods of image processing of one or more embodiments disclosed herein.

In a fourth aspect, according to one or more embodiments disclosed herein, there is provided a non-transitory computer storage medium. The non-transitory computer storage medium stores program codes, the program codes, when executed by a computer device, causing the computer device to execute the method of image processing provided based on one or more embodiments disclosed herein.

### BRIEF DESCRIPTION OF THE DRAWINGS

By combining the accompanying drawings and referring to the following DESCRIPTION, the above and other features, advantages, and aspects of each embodiment disclosed in this disclosure will become more prominent. Throughout the figures, the same or similar figure markers indicate the same or similar elements. It should be understood that the attached drawings are illustrative, and the original and elements may not necessarily be drawn to scale.

FIG. 1 is a flowchart of an image processing method provided by embodiments according to the present disclosure;

FIG. 2 is a schematic diagram of the region to be smoothed provided by the embodiments disclosed in this disclosure;

FIG. 3 is a flowchart of an method of image processing provided by another embodiment of this disclosure;

FIG. 4 is a schematic diagram of the structure of an image processing apparatus provided by an embodiment according to the present disclosure; and

FIG. 5 is a schematic diagram of the structure of an electronic device provided according to an embodiment disclosed herein.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments described herein. Instead, these embodiments are provided for a more thorough and complete understanding of the present disclosure. It should be understood that the accompanying drawings and attachments disclosed herein are for illustrative purposes only and are not intended to limit the scope of protection of this disclosure.

It should be understood that the steps recorded in the disclosed embodiments may be executed in different orders and/or in parallel. In addition, the implementation method may include additional steps and/or omitting the steps shown for execution. The scope of this disclosure is not limited in this regard.

The term “including” and its variations used in this article are open-ended, meaning “including but not limited to”. The term “based on” means “at least partially based on”. The term “one embodiment” means “at least one embodiment”. The term “another embodiment” means “at least one other embodiment”. The term “some embodiments” means “at least some embodiments”. The term “responsive to” and related terms refer to a signal or event being affected to a certain extent by another signal or event, but not necessarily completely or directly. If event x occurs in response to event y, then x may directly or indirectly respond to y. For example, the appearance of y may ultimately lead to the appearance of x, but there may be other intermediate events and/or conditions. In other cases, y may not necessarily lead to the appearance of x, and even if y has not yet occurred, x may also occur. In addition, the term “responsive to” may also mean “at least partially responsive to”.

The term “determine” encompasses a wide range of actions, including observation, calculus, computation, processing, deduction, research, searching (e.g. searching in tables, databases, or other data structures), exploration, and similar actions. It may also include receiving (e.g. receiving information), accessing (e.g. accessing data in storage), and similar actions. It may also include receiving generation, creation, establishment, and similar actions, as well as parsing, selecting, selecting, and similar actions, and so on. The relevant definitions of other terms will be provided in the following description. The relevant definitions of other terms will be provided in the following description.

It should be noted that the concepts such as “first” and “second” mentioned in this disclosure are only used to distinguish different devices, modules or units, and are not intended to limit the order or interdependence of the functions performed by these devices, modules or units.

It should be noted that the modifications of “one” and “multiple” mentioned in this disclosure are illustrative rather than restrictive, and those skilled in the art should understand that unless otherwise explicitly stated in the context, they should be understood as “one or more”.

For the purpose of this disclosure, the phrase “A and/or B” means (A), (B), or (A and B).

The names of the messages or information exchanged between multiple devices in this disclosed embodiment are for illustrative purposes only and are not intended to limit the scope of these messages or information.

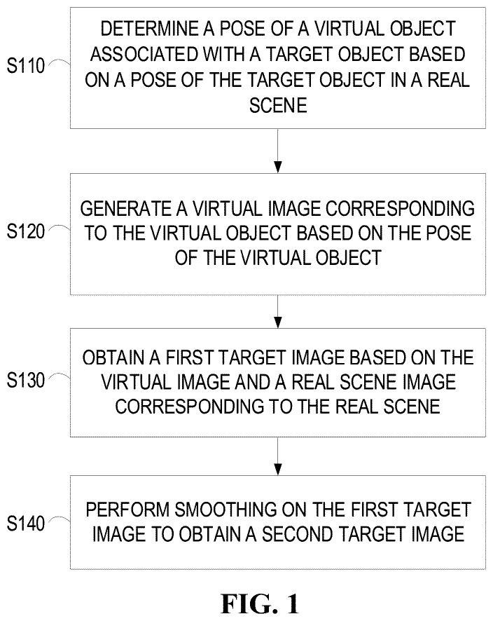

Referring to FIG. 1, it illustrates an image processing method provided by the embodiments disclosed herein, comprising steps S110 to S140.

Step S110: determine a pose of a virtual object associated with a target object based on a pose of the target object in a real scene.

In some embodiments, the target object is a real object that needs to be added as a virtual object in the real scene image presented to the user. It may be a part of the human body, such as limbs, hands, neck, or head, and may also be an animal, plant, or object present in the real scene, but this disclosure is not limited to this. Virtual objects may be virtual objects used to add to the target object. In a specific application scenario, the target object may be the hand of the user and/or the control handle of the virtual reality device held by the user, and its associated virtual objects may be gloves, game props, or other given virtual objects, thus presenting the display effect of the user wearing gloves and holding virtual objects in the virtual reality space.

In some embodiments, the pose of an object may include its position and/or posture (such as rotation angle or direction). In a concrete implementation, the pose of an object includes position information and pose information. The position information indicates the amount of movement along the x, y, z direction of the three right-angle coordinate axes. The pose information indicates the amount of rotation around these three coordinate axes. The position information and attitude information involves a total of six degrees of freedom (i.e., 6DOF).

In a description, a pre-determined object tracking algorithm may be used to track the target object and obtain its pose.

In a description, one or more methods based on vision, laser, or sensor may be used to determine the pose of the target object, and this disclosure is not limited here.

Step S120: generate a virtual image corresponding to the virtual object based on the pose of the virtual object.

In some embodiments, a virtual model corresponding to the virtual object may be predetermined. After obtaining the pose of the virtual object, the virtual model may be adjusted based on the pose to obtain a virtual image containing the virtual object. For example, the virtual model may be loaded into memory in advance, and the pose of the virtual model may be obtained by tracking the target object. Based on the pose of the virtual object and the preloaded model, the virtual model may be rasterized to obtain a depth map (i.e. virtual image) corresponding to the virtual object. For example, the depth map corresponding to the virtual object only has the corresponding depth in the virtual model part, and there is no depth in the remaining parts.

Step S130: obtain a first target image based on the virtual image and a real scene image corresponding to the real scene.

Real scene images may be images captured by cameras of virtual reality devices, or images obtained through predetermined processing steps. In a concrete implementation, real scene images may be obtained based on video see-through (VST).

In some embodiments, real scene images may be depth maps of real scenes. For example, the depth map of a virtual object may be overlaid with the depth map of a real scene to obtain the first target image, thereby achieving coarse fusion between the real scene and the virtual object. In the first target image, the virtual object may replace, cover, or be located at the predetermined position of the target object.

Step S140: perform smoothing on the first target image to obtain a second target image.

In some embodiments, the smoothing process may specifically include local smoothing, that is, smoothing the boundary of the virtual object in the first target image, and it may further include overall smoothing, that is, smoothing the entire first target image after local smoothing. In a specific embodiment, local smoothing includes Laplacian smoothing. The overall smoothing process includes Gaussian filtering. For example, a Gaussian filtering process with a filtering kernel of 3*3 may be applied to the first target image as a whole, but this disclosure is not limited to this.

In this embodiment, local smoothing of the boundary of virtual objects may reduce the distortion caused by adding virtual objects to real scene images. In addition, overall smoothing of the overall image after local smoothing may reduce the image noise and distortion caused by local smoothing.

In some embodiments, the second target image may be a depth image, which may be used for three-dimensional reconstruction and texture mapping, and ultimately rendered on screen. Three-dimensional reconstruction is used to capture the three-dimensional geometric information of a scene, while texture mapping uses images, functions, or other data sources to alter the appearance of object edges. For example, a mesh model may be generated based on the depth data in the second target image, and texture maps and coordinates may be generated based on the mesh model and corresponding RGB images. The rendering may be performed based on information such as the mesh model, texture map, and texture coordinates, and projected onto two eye coordinate systems for display.

According to one or more embodiments disclosed herein, a pose of a virtual object is determined based on a pose of a target object. A virtual image is generated based on the pose of the virtual object. A first target image is obtained based on the virtual image and the real scene image. Finally, a smoothing is performed on the first target image to obtain a second target image. Thus the addition of virtual objects to target objects in real scene images is achieved. Moreover, the image distortion and image noise due to the addition may be reduced.

In some embodiments, the specific steps of performing local smoothing on the boundary of the virtual object in the first target image include:

Step A1: determine a region to be smoothed containing a boundary of the virtual image in the first target image based on the boundary.

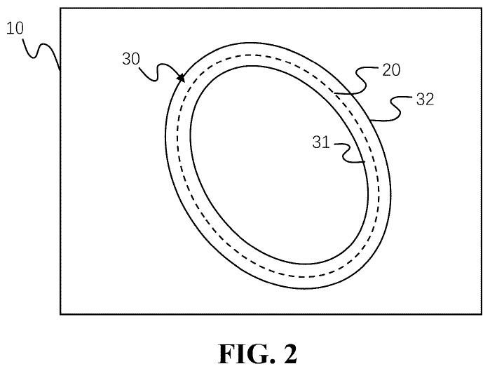

For example, a circular region to be smoothed with a width of predetermined pixels may be determined centered around the boundary of the virtual image. Referring to FIG. 2, in the first target image 10, the boundary 20 of the virtual object is shown in FIG. 2. Assuming that the predetermined pixels are 8 pixels, an inner contour 31 that is 4 pixels apart from the boundary 20 and of the same shape may be determined inwardly from the boundary 20, and an outer contour 32 that is 4 pixels apart from the boundary 20 and of the same shape may be determined outwardly from the boundary 20. The boundary 20 is located between the inner contour 31 and the outer contour 32. The inner contour 31 and the outer contour 32 form a region 30 to be smoothed with a width of 8 pixels.

Step A2: Determine a target depth value of each pixel in the region to be smoothed. The determined target depth value of each pixel is as close as possible to an original depth value of the pixel and target depth values of adjacent pixels of the pixel as a whole.

In this embodiment, the target depth values between adjacent pixels in the region to be smoothed should be as close as possible to each other to make the image smoother. The target depth values of each pixel should not deviate from their original depth values as much as possible to prevent image distortion.

In some embodiments, the adjacent pixels include a pixel adjacent in the first direction and a pixel adjacent in the second direction. The first direction and the second direction are perpendicular to each other. For example, pixels adjacent to pixel A may include a pixel directly above or below that pixel, as well as a pixel to the left or right of pixel A. In this way, because the target depth value of each pixel in the region to be smoothed is associated with one pixel adjacent to it in the first direction (such as directly above) and one pixel adjacent to it in the second direction (such as on the right), the target depth value of each pixel is eventually exactly associated with its four neighboring pixels (such as top, bottom, left, and right), without duplicate calculations.

In some descriptions, an energy function may be constructed based on the accumulation of the square of the difference between the target depth value and the original depth value of each pixel, as well as the accumulation of the square of the difference between the target depth value of each pixel and the target depth values of the adjacent pixels, to obtain the target depth value of each pixel by minimizing the energy function. For example, the energy function E may be constructed as follows:

$$E = {\sum }_{i j} {( {d}_{ij} - {\hat{d}}_{i j} )}^{2} + {\sum }_{i j} λ ( {( {d}_{i j} - {d}_{i + 1 , j} )}^{2} + {( {d}_{i j} - {d}_{i , j + 1} )}^{2} )$$

where dᵢⱼ represents the target depth value of the (i, j)^{th} pixel to be calculated in the region to be smoothed. Similarly, d_{i+1,j} represents the target depth value of the (i+1, j)^{th} pixel to be calculated. d_{i,j+1} represents the target depth value of the (i, j+1)^{th} pixel to be calculated. \hat{d}ᵢⱼ represents the depth value of the (i, j)^{th} pixel in the first target image (i.e., the original depth value). A is referred as to a smoothness coefficient. For example, i corresponds to the number of pixels in the horizontal direction and j corresponds to the number of pixels in the vertical direction.

In this way, by minimizing the energy function, the target depth value of each pixel in the region to be smoothed may be obtained as follows:

$$\{ {d}_{i j} \} = {argmin}_{\{ {d}_{i j} \}} E = {argmin}_{\{ {d}_{i j} \}} {\sum }_{i j} {( {d}_{ij} - {\hat{d}}_{i j} )}^{2} + {\sum }_{i j} λ ( {( {d}_{i j} - {d}_{i + 1 , j} )}^{2} + {( {d}_{i j} - {d}_{i , j + 1} )}^{2} )$$

In some embodiments, the (i+1, j)^{th} pixel may be the neighboring pixel located to right of the (i, j)^{th} pixel. The (i, j+1)^{th} pixel may be the neighboring pixel located on top of the (i, j) th pixel.

In some embodiments, the smoothing coefficient (i.e., weight value) may be a fixed constant (e.g. 0.3). The larger the smoothing coefficient, the greater the weight of the accumulation of the square of the differences between the target depth values of each pixel and its adjacent pixels in the energy function. As a result, the closer the target depth values of each pixel are obtained, the higher the smoothing intensity.

In some embodiments, the squares of the differences between the target depth values of the adjacent pixels correspond to respective weight values, which may be determined based on color deviations among the adjacent pixels. For example, it may be determined based on the square of the difference in color values (such as RGB values) between adjacent pixels. In a description, the energy function E may be constructed as follows:

$$E = {\sum }_{i j} {( {d}_{ij} - {\hat{d}}_{i j} )}^{2} + {\sum }_{i j} ( {{λ}_{i j} ( {d}_{ij} - {d}_{i + 1 , j} )}^{2} + {{λ}_{i j}^{′} ( {d}_{ij} - {d}_{i , j + 1} )}^{2} )$$

where λᵢⱼ=ƒ(cᵢⱼ−c_{i+1,j}), λᵢⱼ′=ƒ(cᵢⱼ−c_{i,j+1}). cᵢⱼ represent the color of the (i, j)^{th} pixel in the region to be smoothed. Similarly, c_{i+1,j} represents the color of the (i+1, j)^{th} pixel in the region to be smoothed. c_{i,j+1} represents the color of the (i, j+1)^{th} pixel in the region to be smoothed. For example, the function ƒ(x) may be an exponential function, such as natural exponential function, but this disclosure is not limited to this.

In this embodiment, by determining, based on the color deviation between the adjacent pixels, the weight value corresponding to the square of the difference between the target depth values of the pair of the adjacent pixels in the energy function, the smoothing effect of the boundary may be further optimized.

In some embodiments, step S110 includes: determining the pose and state of the virtual object based on the pose and state of the target object in the real scene. Step S120 includes generating a virtual image corresponding to the virtual object based on its pose and state.

The state of an object may include its form, posture, or shape. The state of a virtual object is related to its type. In a concrete implementation, when the target object is a real hand and the virtual object is a virtual hand or glove, the gesture or hand shape of the virtual object may be determined based on the gesture or hand shape of the target object, and according to the predetermined virtual model corresponding to different gestures or hand shapes of the virtual object. Thus the final gesture or hand shape of the virtual object may match the gesture or hand shape of the target object in the real scene. In another detailed description, when the target object is a real hand and the virtual object is a virtual pistol prop, the firing state of the virtual pistol prop may be determined based on the gesture or hand shape of the target object (such as trigger, safety state). For example, when the user shows a bent index finger gesture or hand shape, the virtual prop pistol may be determined to be in the firing state of pulling the trigger, but which is not limited in the present disclosure.

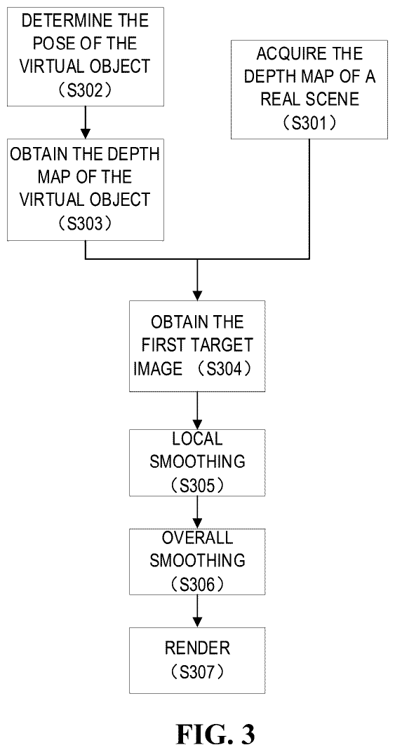

Referring to FIG. 3, it illustrates a method of image processing provided by an embodiment disclosed herein, comprising steps S301 to S307:
Step S301: acquire the depth map of a real scene;
Step S302: determine the pose of the virtual object associated with the target object based on the pose of the target object in the real scene;
Step S303: obtain the depth map of the virtual object based on rasterizing the virtual model of the virtual object based on the pose of the virtual object;
Step S304: obtain the first target image based on the depth map of the virtual object and the depth map of the real scene;
Step S305: perform local smoothing on the boundary of the virtual objects in the first target image;
Step S306: perform overall smoothing on the first target image after local smoothing to obtain the second target image;
Step S307: perform 3D reconstruction and texture mapping based on the second target image, and render. 3D reconstruction is used to capture the three-dimensional geometric information of a scene, while texture mapping uses images, functions, or other data sources to alter the appearance of object edges. For example, a mesh model may be generated based on the depth data in the second target image, and texture maps and coordinates may be generated based on the mesh model and corresponding RGB images. The rendering may be performed based on information such as the mesh model, texture map, and texture coordinates, and projected onto two eye coordinate systems for display.

According to one or more embodiments disclosed herein, a pose of a virtual object is determined based on a pose of a target object. A virtual image is generated based on the pose of the virtual object. A first target image is obtained based on the virtual image and the real scene image. Finally, a smoothing is performed on the first target image to obtain a second target image. Thus the addition of virtual objects to target objects in real scene images is achieved. Moreover, the image distortion and image noise due to the addition may be reduced.

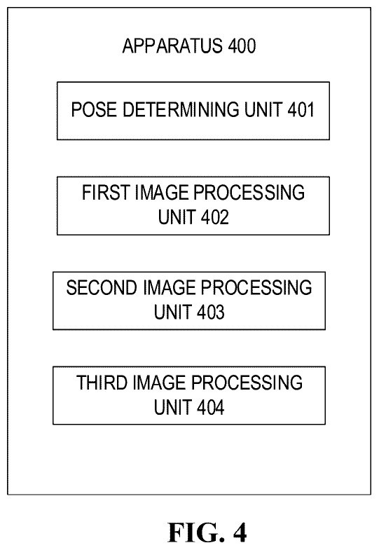

Correspondingly, referring to FIG. 4, an image processing apparatus 400 is provided according to an embodiment disclosed herein, comprising:
a pose determining unit 401 configured to determine a pose of a virtual object associated with a target object based on a pose of the target object in a real scene;
a first image processing unit 402 configured to generate a virtual image corresponding to the virtual object based on the pose of the virtual object;
a second image processing unit 403 configured to obtain a first target image based on the virtual image and a real scene image corresponding to the real scene; and
a third image processing unit 404 configured to perform smoothing on the first target image to obtain a second target image.

In some embodiments, the third image processing unit includes:
A local smoothing unit is used to perform local smoothing on the boundary of the virtual object in the first target image.

In some embodiments, the third image processing unit also includes:
An overall smoothing unit configured to perform overall smoothing on the first target image after local smoothing.

In some embodiments, the local smoothing units includes:
A region determination unit configured to determining a region to be smoothed based on the boundary of the virtual image in the first target image, including the boundary; and
A depth determining unit configured to determine the target depth value of each pixel in the region to be smoothed, where the target depth value of each pixel is determined to be as close as possible to its original depth value and the target depth value of its adjacent pixels as a whole.

In some embodiments, the depth determination unit is used to construct an energy function based on the accumulation value of the square of the difference between the target depth value of each pixel and the original depth value of each pixel, as well as the accumulation value of the square of the difference between the target depth value of each pixel and its adjacent pixels, and to obtain the target depth value of each pixel by minimizing the energy function.

In some embodiments, the adjacent pixels include a pixel adjacent in the first direction and a pixel adjacent in the second direction, where the first direction and the second direction are perpendicular to each other.

In some embodiments, the square of the difference in target depth values between adjacent pixels in the energy function corresponds to a corresponding weight value, which is determined based on the color deviation between adjacent pixels.

In some embodiments, the overall smoothing process includes Gaussian processing.

In some embodiments, the pose determining unit is configured to determine the pose and state of the virtual object based on the pose and state of the target object in the real scene. The first image processing unit is configured to generate a virtual image corresponding to the virtual object based on its pose and state.

In some embodiments, performing the apparatus of image processing further comprises:
A rendering unit used configured to 3D reconstruction and texture mapping based on the second target image, and for rendering.

For the embodiments of the device, as they basically correspond to method embodiments, please refer to the section on method embodiments for relevant information. The device embodiments described above are only illustrative, and the modules described as separate modules may or may not be separate. Some or all modules may be selected according to actual needs to achieve the purpose of this embodiments scheme. Ordinary technical personnel in this field may understand and implement it without creative labor.

Correspondingly, according to one or more embodiments disclosed herein, an electronic device is provided comprising:
At least one memory and at least one processor;
The memory is configured to store program codes, and the processor is configured to call the program codes stored in the memory to cause the electronic device to execute the methods of one or more embodiments disclosed herein.

Correspondingly, according to one or more embodiments disclosed herein, a non-transitory computer storage medium is provided. The non-transitory computer storage medium stores program codes. The program codes, when executed by a computer device, cause the computer device to execute the methods of one or more embodiments disclosed herein.

According to one or more embodiments disclosed herein, a pose of a virtual object is determined based on a pose of a target object. A virtual image is generated based on the pose of the virtual object. A first target image is obtained based on the virtual image and the real scene image. Finally, a smoothing is performed on the first target image to obtain a second target image. Thus the addition of virtual objects to target objects in real scene images is achieved. Moreover, the image distortion and image noise due to the addition can be reduced.

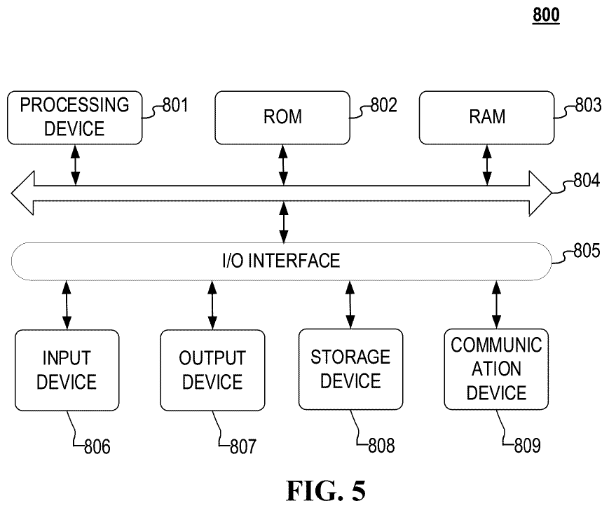

Referring to FIG. 5 below, a schematic diagram of the structure of an electronic device (such as a terminal device or server) 800 suitable for implementing the disclosed embodiments is shown. The terminal devices in this disclosure may include, but are not limited to, mobile phones, laptops, digital broadcast receivers Personal Digital Assistant (PDA), tablet computer (PAD) Mobile terminals such as PMP (portable multimedia player) and in car terminals (such as in car navigation terminals), as well as fixed terminals such as digital TVs and desktop computers. The electronic device shown in FIG. 5 is only an example and should not impose any limitations on the functionality and scope of use of the disclosed embodiments.

As shown in FIG. 5, electronic device 800 may include a processing device (such as a central processing unit, graphics processor, etc.) 801, which may perform various appropriate actions and processes based on programs stored in read-only memory (ROM) 802 or programs loaded from storage device 808 into random access memory (RAM) 803. In RAM 803, various programs and data required for the operation of electronic device 800 are also stored. Processing device 801 ROM 802 and RAM 803 are connected to each other via bus 804. The input/output (I/O) interface 805 is also connected to bus 804.

Typically, the following devices may be connected to the I/O interface 805. The I/O interface 805 includes, for example, touch screens, touchpads, keyboards, mice, cameras, microphones, accelerometers, gyroscopes, etc., and includes output devices such as liquid crystal displays (LCDs), speakers, vibrators, etc. 807; Including storage devices such as magnetic tapes, hard drives, etc. 808; And communication device 809. The communication device 809 may allow electronic device 800 to communicate wirelessly or wired with other devices to exchange data. Although FIG. 5 illustrates electronic device 800 with various devices, it should be understood that it is not required to implement or have all the shown devices. It may be implemented or equipped with more or fewer devices as an alternative.

Specifically, according to the disclosed embodiments, the process described above with reference to the flowchart may be implemented as a computer software program. For example, the embodiments disclosed herein include a computer program product comprising a computer program carried on a computer readable medium, which includes program code for executing the method shown in the flowchart. In such embodiments, the computer program may be downloaded and installed from the network through communication device 809, or installed from storage device 808 or ROM 802. When the computer program is executed by the processing device 801, the above-mentioned functions defined in the methods disclosed in this disclosure are executed.

It should be noted that the computer-readable medium mentioned in this disclosure may be a computer readable signal medium, a computer readable storage medium, or any combination of the two. A computer-readable storage medium may be, but is not limited to, an electrical, magnetic, optical, electromagnetic, infrared, or semiconductor system, device, or device, or any combination thereof. More specific examples of computer readable storage media may include, but are not limited to: electrical connections with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In this disclosure, a computer readable storage medium may be any tangible medium containing or storing a program, which may be used by an instruction execution system, device, or device, or in combination with it. In this disclosure, computer-readable signal media may include data signals propagated in the baseband or as part of the carrier wave, which carry computer-readable program code. This type of transmitted data signal may take various forms, including but not limited to electromagnetic signals, optical signals, or any suitable combination of the above. A computer-readable signal medium may also be any computer readable medium other than a computer readable storage medium, which may send, propagate, or transmit programs for use by instruction execution systems, devices, or devices, or in combination with them. The program code contained on computer-readable media may be transmitted using any appropriate medium, including but not limited to: wires, optical cables RF (radio frequency), etc., or any suitable combination of the above.

In some implementations, clients and servers may communicate using any currently known or future developed network protocol, such as HTTP (HyperText Transfer Protocol), and may interconnect with any form or medium of digital data communication (such as communication networks). Examples of communication networks include local area networks (“LANs”), wide area networks (“WANs”), the Internet (for example, the Internet), and end-to-end networks (for example, Ad hoc end-to-end networks, as well as any currently known or future developed networks.

The above-mentioned computer-readable medium may be included in the electronic device mentioned above. It may also exist separately without being assembled into the electronic device.

The above-mentioned computer-readable medium carries one or more programs, which, when executed by the electronic device, cause the electronic device to execute the methods disclosed herein.

Computer program code for executing the operations disclosed herein may be written in one or more programming languages or combinations thereof, including object-oriented programming languages such as Java Smalltalk and C++. This also includes conventional procedural programming languages such as C or similar programming languages. Program code may be completely executed on the user's computer, partially executed on the user's computer, executed as an independent software package, partially executed on the user's computer, partially executed on a remote computer, or completely executed on a remote computer or server. In cases involving remote computers, remote computers may connect to user computers through any type of network, including local area networks (LANs) or wide area networks (WANs), or may connect to external computers (such as using internet service providers to connect via the internet).

The flowchart and block diagram in the attached figure illustrate the possible architecture, functions, and operations of the systems, methods, and computer program products implemented in accordance with various embodiments disclosed herein. At this point, each box in a flowchart or block diagram may represent a module, program segment, or part of code that contains one or more executable instructions for implementing a specified logical function. It should also be noted that in some alternative implementations, the functions indicated in the box may also occur in a different order than those indicated in the accompanying drawings. For example, two consecutive boxes may actually be executed in basic parallel, and sometimes they may also be executed in opposite order, depending on the functionality involved. It should also be noted that each box in the block diagram and/or flowchart, as well as the combination of boxes in the block diagram and/or flowchart, may be implemented using dedicated hardware based systems that perform specified functions or operations, or may be implemented using a combination of dedicated hardware and computer instructions.

The units described in this disclosed embodiment may be implemented through software or hardware. Among them, the name of the unit does not constitute a limitation on the unit itself in a certain situation.

The functions described above in this article may be at least partially executed by one or more hardware logic components. For example, non restrictive demonstration types of hardware logic components that may be used include: Field Programmable Gate Arrays (FPGAs), Application Specific Integrated Circuits (ASICs), Application Specific Standard Products (ASSPs), Systems on Chip (SOC), Complex Programmable Logic Devices (CPLDs), and so on.

In the context of this disclosure, machine readable media may be tangible media that may contain or store programs for use by or in combination with instruction execution systems, devices, or devices. Machine readable media may be machine readable signal media or machine readable storage media. Machine readable media may include but are not limited to electronic, magnetic, optical, electromagnetic, infrared, or semiconductor systems, devices, or devices, or any suitable combination of the above. More specific examples of machine readable storage media may include electrical connections based on one or more lines, portable computer disks, hard drives, random access memory (RAM), read-only memory (ROM), erasable programmable read-only memory (EPROM or flash memory), optical fibers, compact disc read-only memory (CD-ROM), optical storage devices, magnetic storage devices, or any suitable combination of the above.

According to one or more embodiments disclosed herein, an method of image processing is provided, comprising: determining a pose of a virtual object associated with a target object based on a pose of the target object in a real scene; generating a virtual image corresponding to the virtual object based on the pose of the virtual object; obtaining a first target image based on the virtual image and a real scene image corresponding to the real scene; and performing smoothing on the first target image to obtain a second target image.

According to one or more embodiments disclosed herein, the first target image is smoothed, including local smoothing of the boundary of the virtual object in the first target image.

According to one or more embodiments disclosed herein, the first target image is smoothed, further comprising: overall smoothing of the first target image after local smoothing.

According to one or more embodiments disclosed herein, local smoothing processing is performed on the boundary of the virtual object in the first target image, including: determining a region to be smoothed containing a boundary of the virtual image in the first target image based on the boundary; Determine the target depth value of each pixel in the region to be smoothed, where the target depth value of each pixel is determined to be as close as possible to its original depth value and the target depth value of its adjacent pixels as a whole.

According to one or more embodiments disclosed herein, determining the target depth value of each pixel in the region to be smoothed includes: constructing an energy function based on an accumulation of a square of a difference between the target depth value and the original depth value of each pixel, and an accumulation of squares of differences between the target depth value of each pixel and the target depth values of the adjacent pixels, and obtaining the target depth value for each pixel by minimizing the energy function.

According to one or more embodiments disclosed herein, the adjacent pixels include a pixel adjacent in the first direction and a pixel adjacent in the second direction. The first direction and the second direction are perpendicular to each other.

According to one or more embodiments disclosed herein, in the energy function, the square value of the difference in target depth values between adjacent pixels corresponds to a corresponding weight value, which is determined based on the color deviation between adjacent pixels.

According to one or more embodiments disclosed herein, the overall smoothing process includes Gaussian filtering processing.

According to one or more embodiments disclosed herein, the pose of a virtual object associated with the target object is determined based on the pose of the target object in a real scene, including: determining the pose and state of the virtual object based on the pose and state of the target object in a real scene; The virtual image corresponding to the virtual object is generated based on the pose of the virtual object, including: generating a virtual image corresponding to the virtual object based on the pose and state of the virtual object.

According to the method provided by one or more embodiments disclosed herein, further comprising: performing 3D reconstruction and texture mapping based on the second target image, and rendering and displaying.

According to one or more embodiments disclosed herein, an image processing apparatus is provided, comprising a pose determining unit for determining the pose of a virtual object associated with the target object based on the pose of the target object in a real scene; A first image processing unit for generating virtual images corresponding to the virtual object based on the pose of the virtual object; The second image processing unit is used to obtain the first target image based on the virtual image and the real scene image corresponding to the real scene; The third image processing unit is used to smooth the first target image and obtain the second target image.

According to one or more embodiments disclosed herein, there is provided an electronic device comprising: at least one memory and at least one processor; Among them, the memory is used to store program code, and the processor is used to call the program code stored in the memory to enable the electronic device to execute the image processing method provided according to one or more embodiments disclosed herein.

A non-transitory computer storage medium is provided according to one or more embodiments disclosed herein. The non-transitory computer storage medium stores program codes. The program codes, when executed by a computer device, cause the computer device to execute the methods of one or more embodiments disclosed herein.

The above description is only for the better embodiments disclosed in this disclosure and an explanation of the technical principles used. Technicians in this field should understand that the scope of disclosure referred to in this disclosure is not limited to technical solutions formed by specific combinations of the aforementioned technical features, and should also cover other technical solutions formed by arbitrary combinations of the aforementioned technical features or their equivalent features without departing from the disclosed concept. For example, a technical solution formed by replacing the above features with (but not limited to) technical features with similar functions disclosed in this disclosure.

Furthermore, although the operations are depicted in a specific order, this should not be understood as requiring them to be executed in the specific order shown or in sequential order. In certain environments, multitasking and parallel processing may be advantageous. Similarly, although several specific implementation details are included in the above discussion, these should not be interpreted as limitations on the scope of this disclosure. Some features described in the context of individual embodiments may also be combined and implemented in a single embodiment. On the contrary, various features described in the context of a single embodiment may also be implemented individually or in any suitable sub combination in multiple embodiments.

Although this topic has been described using language specific to structural features and/or method logic actions, it should be understood that the topics limited in the attached claims may not necessarily be limited to the specific features or actions described above. On the contrary, the specific features and actions described above are only examples of implementing claims.

1. A method of image processing, comprising:
determining a pose of a virtual object associated with a target object based on a pose of the target object in a real scene;
generating a virtual image corresponding to the virtual object based on the pose of the virtual object;
obtaining a first target image based on the virtual image and a real scene image corresponding to the real scene; and
performing smoothing on the first target image to obtain a second target image.

2. The method of claim 1, wherein the performing smoothing on the first target image comprises:
performing local smoothing on a boundary of the virtual object in the first target image.

3. The method of claim 2, wherein the performing smoothing on the first target image further comprises:
performing overall smoothing on the first target image after the local smoothing.

4. The method of claim 2, wherein the performing local smoothing on a boundary of the virtual object in the first target image comprises:
determining a region to be smoothed containing a boundary of the virtual image in the first target image based on the boundary; and
determining a target depth value of each pixel in the region to be smoothed, wherein the determined target depth value of each pixel is as close as possible to an original depth value of the pixel and target depth values of adjacent pixels of the pixel as a whole.

5. The method of claim 4, wherein the determining a target depth value of each pixel in the region to be smoothed comprises:
constructing an energy function based on an accumulation of a square of a difference between the target depth value and the original depth value of each pixel, and an accumulation of squares of differences between the target depth value of each pixel and the target depth values of the adjacent pixels; and
obtaining the target depth value for each pixel by minimizing the energy function.

6. The method of claim 4, wherein the adjacent pixels comprise a pixel adjacent in a first direction and a pixel adjacent in a second direction, and the first direction and the second direction are perpendicular to each other.

7. The method of claim 5, wherein in the energy function, the squares of the differences between the target depth values of the adjacent pixels correspond to respective weight values, which are determined based on color deviations among the adjacent pixels.

8. The method of claim 3, wherein the overall smoothing comprises Gaussian filtering processing.

9. The method of claim 1, wherein the determining a pose of a virtual object associated with a target object based on a pose of the target object in a real scene comprises: determining a pose and a state of a virtual object based on a pose and a state of the target object in a real scene; and
the generating a virtual image corresponding to the virtual object based on the pose of the virtual object comprises: generating the virtual image corresponding to the virtual object based on the pose and the state of the virtual object.

10. The method of claim 1, further comprising:
performing, based on the second target image, 3-Dimensional reconstruction and texture mapping and rendering.

11. An electronic device, comprising:
at least one memory and at least one processor;
wherein the memory is configured to store program codes, and the processor is configured to call the program codes stored in the memory to cause the electronic device to execute acts comprising:
determining a pose of a virtual object associated with a target object based on a pose of the target object in a real scene;
generating a virtual image corresponding to the virtual object based on the pose of the virtual object;
obtaining a first target image based on the virtual image and a real scene image corresponding to the real scene; and
performing smoothing on the first target image to obtain a second target image.

12. The device of claim 11, wherein the performing smoothing on the first target image comprises:
performing local smoothing on a boundary of the virtual object in the first target image.

13. The device of claim 12, wherein the performing smoothing on the first target image further comprises:
performing overall smoothing on the first target image after the local smoothing.

14. The device of claim 12, wherein the performing local smoothing on a boundary of the virtual object in the first target image comprises:
determining a region to be smoothed containing a boundary of the virtual image in the first target image based on the boundary; and
determining a target depth value of each pixel in the region to be smoothed, wherein the determined target depth value of each pixel is as close as possible to an original depth value of the pixel and target depth values of adjacent pixels of the pixel as a whole.

15. The device of claim 14, wherein the determining a target depth value of each pixel in the region to be smoothed comprises:
constructing an energy function based on an accumulation of a square of a difference between the target depth value and the original depth value of each pixel, and an accumulation of squares of differences between the target depth value of each pixel and the target depth values of the adjacent pixels; and
obtaining the target depth value for each pixel by minimizing the energy function.

16. The device of claim 14, wherein the adjacent pixels comprise a pixel adjacent in a first direction and a pixel adjacent in a second direction, and the first direction and the second direction are perpendicular to each other.

17. The device of claim 15, wherein in the energy function, the squares of the differences between the target depth values of the adjacent pixels correspond to respective weight values, which are determined based on color deviations among the adjacent pixels.

18. The device of claim 13, wherein the overall smoothing comprises Gaussian filtering processing.

19. The device of claim 11, wherein the determining a pose of a virtual object associated with a target object based on a pose of the target object in a real scene comprises: determining a pose and a state of a virtual object based on a pose and a state of the target object in a real scene; and
the generating a virtual image corresponding to the virtual object based on the pose of the virtual object comprises: generating the virtual image corresponding to the virtual object based on the pose and the state of the virtual object.

20. A non-transitory computer storage medium, wherein the non-transitory computer storage medium stores program codes, wherein the program codes, when executed by a computer device, cause the computer device to execute acts comprising:
determining a pose of a virtual object associated with a target object based on a pose of the target object in a real scene;
generating a virtual image corresponding to the virtual object based on the pose of the virtual object;
obtaining a first target image based on the virtual image and a real scene image corresponding to the real scene; and
performing smoothing on the first target image to obtain a second target image.
